(19) United States
(12) Patent Application Publication
(10) Pub. No.: US 2017/0293814 A1
(43) Pub. Date: Oct. 12, 2017

(54) System and Method for Inspecting Road Surfaces

(71) Applicant: Ford Global Technologies, LLC, Dearborn, MI (US)

(72) Inventors: Larry Dean ELIE, Ypsilanti, MI (US); Allan Roy GALE, Livonia, MI (US)

(21) Appl. No.: 15/092,743

(22) Filed: Apr. 7, 2016

(51) Int. Cl. G06K 9/00; B60R 11/04; H04N 5/33; H04N 5/225; G06K 9/46

(52) U.S. Cl. CPC G06K 9/00805; G06K 9/00798; H04N 5/2256; G06K 9/4661; H04N 5/33; B60R 11/04; B60R 2300/8093; B60W 2400/00

(57) ABSTRACT

A method of inspecting a road for substances includes generating a flash of infra-red light at a wavelength to illuminate a portion of the road. The wavelength corresponds to an absorption wavelength of a substance to be detected. The method further includes, in response to a difference in backscatter intensity of an image of the portion captured during the flash and an image of the portion captured before or after the flash being greater than a threshold amount, outputting a signal indicating presence of the substance on the portion.

### TECHNICAL FIELD

The present disclosure relates to a system and method for inspecting road surfaces with a vision system disposed on a vehicle. The road data captured by the vision system can be utilized to warn the driver and/or modify active and semi-active systems of the vehicle.

### BACKGROUND

Road conditions vary greatly due to inclement weather and infrastructure. The driving experience of a motor vehicle can be improved by dynamically adapting systems of the vehicle to mitigate the effects of road-surface irregularities or whether-based issues such as ice, snow, or water. Some vehicles include active and semi-active systems (such as vehicle suspension and automatic-braking systems) that may be adjusted based on road conditions.

### SUMMARY

According to one embodiment, a method of inspecting a road for substances includes generating a flash of infra-red light at a wavelength to illuminate a portion of the road. The wavelength corresponds to an absorption wavelength of a substance to be detected. The method further includes, in response to a difference in backscatter intensity of an image of the portion captured during the flash and an image of the portion captured before or after the flash being greater than a threshold amount, outputting a signal indicating presence of the substance on the portion.

According to another embodiment, a method of inspecting a road for oil includes generating a flash of infra-red light at an oil-absorption wavelength to illuminate a portion of the road. The method further includes, in response to a difference in backscatter intensity of an image of the portion captured during the flash and an image of the portion captured before or after the flash being greater than a threshold amount, outputting a signal indicating presence of oil on the portion.

According to yet another embodiment, a vehicle includes an infrared source configured to emit light at an oil-absorption wavelength, and a camera. A controller of the vehicle is programmed to command the infrared source to illuminate a portion of the road with a flash of the light. The controller is further programmed to command the camera to capture a first image of the portion during the flash, and command the camera to capture a second image of the portion before or after the flash. The controller is also programmed to, in response to a difference in backscatter intensity of the first image and the second image being greater than a threshold amount, output a signal indicating presence of oil on the portion.

### BRIEF DESCRIPTION OF THE DRAWINGS

FIG. 1 is a schematic diagram of a vehicle.

FIG. 2 is a schematic diagram of a plenoptic camera.

FIG. 3 is a flowchart illustrating an example method for detecting a substance on a road surface.

FIG. 4 is a diagrammatical view of the vehicle detecting substances and hazards on a road.

FIG. 5 is a flowchart for generating an enhanced depth map.

FIG. 6 illustrates a flow chart for controlling a suspension system, an anti-lock braking system, and a stability-control system.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Referring to FIG. 1, a vehicle 20 includes a body structure 22 supported by a chassis. Wheels 24 are connected to the chassis via a suspension system 26 that includes at least springs 33, dampeners 41, and linkages. The vehicle 20 also includes an anti-lock braking system (ABS) 23 having at least a master cylinder, rotors 27, calipers 29, a valve-and-pump housing 25, brake lines 31, and wheel sensors (not shown). The vehicle also includes a steering system including a steering wheel fixed on a steering shaft that is connected to a steering rack (or steering box) that is connected to the front wheels via tie rods or other linkages. A sensor may be disposed on the steering shaft to determine a steering angle of the system. The sensor is in electrical communication with the controller 46 and is configured to output a single indicative of the steering angle.

The vehicle 20 includes a vision system 28 attached to the body structure 22 (such as the front bumper). The vision system 28 includes a camera 30. The camera may be a plenoptic camera (also known as a light-field camera, an array camera, or a 4D camera), or may be a multi-lens stereo camera. The vision system 28 also includes at least one light source—such as a first light source 32, a second light source 34, and a third light source 37. The first, second, and third light sources 32, 34, 37 may be near infrared (IR) light-emitting diodes (LED) or diode lasers. The vision system 28 may be located on a front end 36 of the vehicle 20. The camera 30 and light sources 32, 34, 37 are pointed at a portion of the road in front of the vehicle 20 to inspect the road. The vision system 28 may be aimed to monitor a portion of the road between 5 and 100 feet in front of the vehicle 20. In some embodiments, the vision system may be pointed directly down at the road.

The vision system 28 is in electrical communication with a vehicle-control system (VSC). The VCS includes one or more controllers 46 for controlling the function of various components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “lookup tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers. The controller 46 receives signals from the vision system 28 and includes memory containing machine-readable instructions for processing the data from the vision system 28. The controller 46 is programmed to output instructions to at least a display 48, an audio system 50, the suspension system 26, and the ABS 23.

Plenotic cameras are able to edit the focal point past the imaged scene and to move the view point within limited borderlines. Plenotic cameras are capable of generating a depth map of the field of view of the camera. A depth map provides depth estimates for pixels in an image from a reference viewpoint. The depth map is utilized to represent a spatial representation indicating the distance of objects from the camera and the distances between objects within the field of view. An example of using a light-field camera to generate a depth map is disclosed in U.S. Patent Application Publication No. 2015/0049916 by Ciurea et al., the contents of which are hereby incorporated by reference in its entirety. The camera 30 can detect, among other things, the presence of several objects in the field of view of the camera, generate a depth map based on the objects detected in the field of view of the camera 30, detect the presence of an object entering the field of view of the camera 30, detect surface variation of a road surface, and detect ice or water on the road surface.

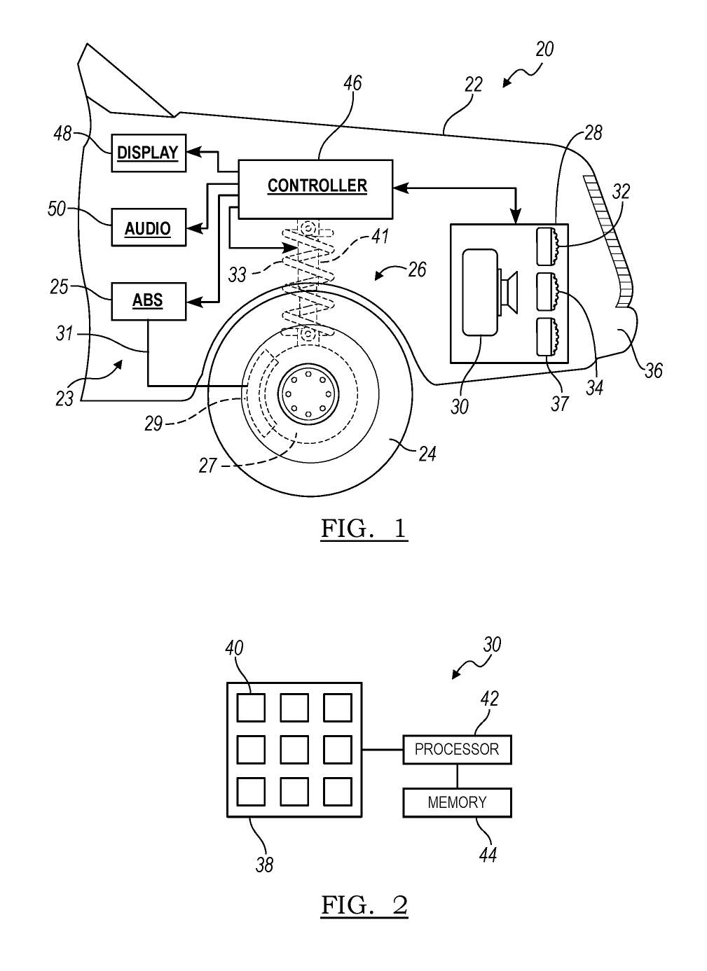

Referring to FIG. 2, the plenoptic camera 30 may include a camera module 38 having an array of imagers 40 (i.e., individual cameras) and a processor 42 configured to read out and process image data from the camera module 38 to synthesize images. The illustrated array includes 9 imagers, however, more or less imagers may be included within the camera module 38. The camera module 38 is connected with the processor 42. The processor 42 is configured to communicate with one or more different types of memory 44 that stores image data and contains machine-readable instructions utilized by the processor 42 to perform various processes, including generating depth maps and detecting ice, water, or oil.

Each of the imagers 40 may include a filter used to capture image data with respect to a specific portion of the light spectrum. For example, the filters may limit each of the cameras to detecting a specific spectrum of near-infrared light. In one embodiment, the array of imagers includes a first set of imagers for detecting a wavelength corresponding to a water-absorption wavelength, a second set of imagers for detecting a wavelength corresponding to an ice-absorption wavelength, and a third set of imagers for detecting a wavelength corresponding to an oil-absorption wavelength. In another embodiment, the imagers are configured to detect a range of near-IR wavelengths.

The camera module 38 may include charge collecting sensors that operate by converting the desired electromagnetic frequency into a charge proportional to the intensity of the electromagnetic frequency and the time that the sensor is exposed to the source. Charge collecting sensors, however, typically have a charge saturation point. When the sensor reaches the charge saturation point sensor damage may occur and/or information regarding the electromagnetic frequency source may be lost. To overcome potentially damaging the charge collecting sensors, a mechanism (e.g., shutter) may be used to proportionally reduce the exposure to the electromagnetic frequency source or control the amount of time the sensor is exposed to the electromagnetic frequency source. However, a trade-off is made by reducing the sensitivity of the charge collecting sensor in exchange for preventing damage to the charge collecting sensor when a mechanism is used to reduce the exposure to the electromagnetic frequency source. This reduction in sensitivity may be referred to as a reduction in the dynamic range of the charge collecting sensor, The dynamic range refers to the amount of information (bits) that may be obtained by the charge collecting sensor during a period of exposure to the electromagnetic frequency source.

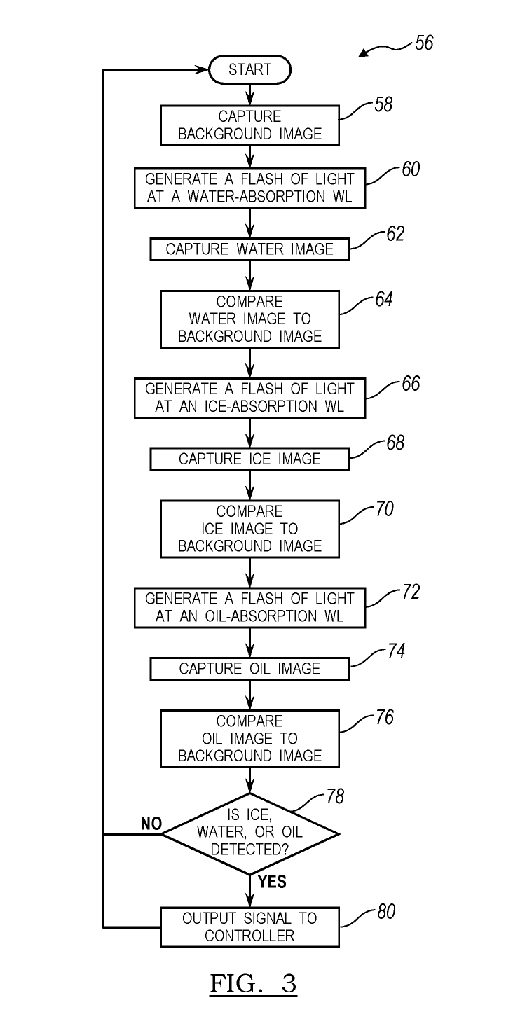

Referring to FIG. 3, the vision system 28 is configured to provide information about the road surface to the driver and to the vehicle in the form of an enhanced depth map if the camera 30 is suitable equipped (e.g., the camera 30 is a plenoptic camera). An enhanced depth map includes data indicating distance information for objects in the field of view, and includes data indicating the presence of ice, water, or oil in the field of view. The visons system 28 inspects an upcoming road segment for various conditions such as potholes, bumps, surface irregularities, ice, oil, and water. The upcoming road segment may be under the front end of the vehicle, or approximately 5 to 100 feet in front of the vehicle. The vision system 28 captures images of the road segment, processes these images, and outputs the data to the controller 46 for use by other vehicle systems.

The vision system 28 can independently detect substances on the road. The vision system detects these substances by emitting light at an absorption wavelength corresponding to the substance to be detected and measuring backscatter of the light to determine presence of the substance on the road. For example, water is detected by emitting light at a water-absorption wavelength and measuring the backscattering of the light with the camera 30. Light at the water-absorption wavelength is absorbed by the water and generally does not reflect back to the camera 30. Thus, water can be is detected based on the intensity of the light detected by the camera 30. Similarly, ice is detected by emitting light at an ice-absorption wavelength and measuring the backscattering of the light with the camera 30. Light at the ice-absorption wavelength is absorbed by the ice and generally does not reflect back to the camera 30. Thus, ice can be detected based on the intensity of light detected by the camera 30. Oil can also be detected by emitting light at an oil-absorption wavelength and measuring the backscattering of the light with the camera 30. Light at the oil-absorption wavelength is absorbed by the oil and generally does not reflect back to the camera 30. Thus, oil can be detected based on the intensity of light detected by the camera 30.

Water, oil, and ice have different near-infrared-absorption frequencies. Therefore, a vision system configured to detect these substances may include at least three near IR light sources, such as light source 32 that emits light at a water-absorption wavelength, light source 34 that emits light at an ice-absorption wavelength, and light source 37 that emits light at an oil-absorption wavelength. Because the absorption wavelengths are typically unique for each substance to be detected, the vision system must detect each substance one at a time. The system may pulse flashes of light at the various absorption wavelengths in a repeating sequence. Each pulse is an intense burst of light at one of the absorption wavelengths for a short period of time, such as 15 milliseconds (ms). The sequence may repeat at a frequency of 100-500 hertz.

Flow chart 56 illustrates one example method of detection. At operation 58 the camera 30 captures a background (or reference) image of a segment of the road. The background image is taken while the light sources of the vision system are OFF. During the capturing of the background image, the road is illuminated with ambient light (e.g., sunlight or headlights), which is typically a broadband spectrum of light. At operation 60 the road is illuminated by light source 32, which emits a pulse of light at the water-absorption wavelength. The water-absorption wavelength may be in the near-IR spectrum so that the light is invisible or almost invisible to humans. Example water-absorption IR wavelengths include: 970, 1200, 1450, and 1950 nanometers (nm). The camera 30 captures a water image of a portion of the road while the portion is illuminated with the water-absorption wavelength at operation 62. This flash of light is more intense at the water-absorption wavelength than the ambient light to prevent the ambient light for interfering with the measurements. At operation 64 the water image is compared to the background image. If a difference in backscatter intensity of the water image and the background image is greater than a threshold amount, it is determined that water is present at that portion of the road.

There are currently several techniques available for comparing images. To detect what portion of the road has water on it, image-segmentation techniques such as “thresholding”, “clustering methods,” or “compression-based methods” may be used. These techniques can detect entire regions lacking a general intensity of light, such as the water-absorption wavelength. Even in a black-and-white image, image segmentation may be more efficient and accurate than comparing on a pixel-by-pixel basis. (In some embodiments, however, pixel-by-pixel comparison may be utilized.) Such a system is capable of easily recognizing a substance (e.g., water) by an absence of a particular IR “color” in one image as compared to a previous image taken without this particular frequency of illumination. In addition, the vision system has the ability to compare an image of this frame to an image taken several frames ago that was illuminated with a same wavelength of illumination. For example, a current water image can be compared to the previous water image, which may be referred to as a “calibration image,” to verify the current image.

At operation 66 the road is illuminated by light source 34, which emits a pulse of light at the ice-absorption wavelength. Example IR ice-absorption wavelengths include: 1620, 3220, and 3500 nm. The camera 30 captures an ice image of a portion of the road while the portion is illuminated with the ice-absorption wavelength at operation 68. This flash of light is more intense at the ice-absorption wavelength than the ambient light. At operation 70 the ice image is compared to the background image. If a difference in backscatter intensity of the ice image and the background image is greater than a threshold amount, it is determined that ice is present at that portion of the road.

At operation 72 the road is illuminated by light source 37, which emits a pulse of light at the oil-absorption wavelength. Example IR oil-absorption wavelengths include: 1725 and 2310 nm. The camera 30 captures an oil image of a portion of the road while the portion is illuminated with the oil-absorption wavelength at operation 74. This flash of light is more intense at the oil-absorption wavelength than the ambient light. At operation 76 the oil image is compared to the background image. If a difference in backscatter intensity of the oil image and the background image is greater than a threshold amount, it is determined that oil is present at that portion of the road.

At operation 78 the system determines if water, ice or oil were detected. At operation 80 the visions system 28 outputs a signal to the controller indicating a presence of ice, water, or oil in response to any of these substances being detected. The signal may include data indicating water detected, water depth, ice detected, ice depth, and oil detection, as well as surface information (e.g., depth of pothole or presences of a hump).

In other embodiments, the visions system 28 does not take a background image illuminated with only ambient light (i.e., with light sources 32, 34, and 37 OFF). Instead, the system uses one of the oil, water, or ice images as a comparative image. For example, the water image can serve as the comparative image for ice, the ice image can serve as the comparative image for oil, and the oil image can serve as the comparative image for water. This has the advantage of taking less images per cycle. In this embodiment, the ice image, for example, is compared to the water image to determine if ice is present similar to step 64 explained above. Similar comparisons would be made for the remaining substances to be detected.

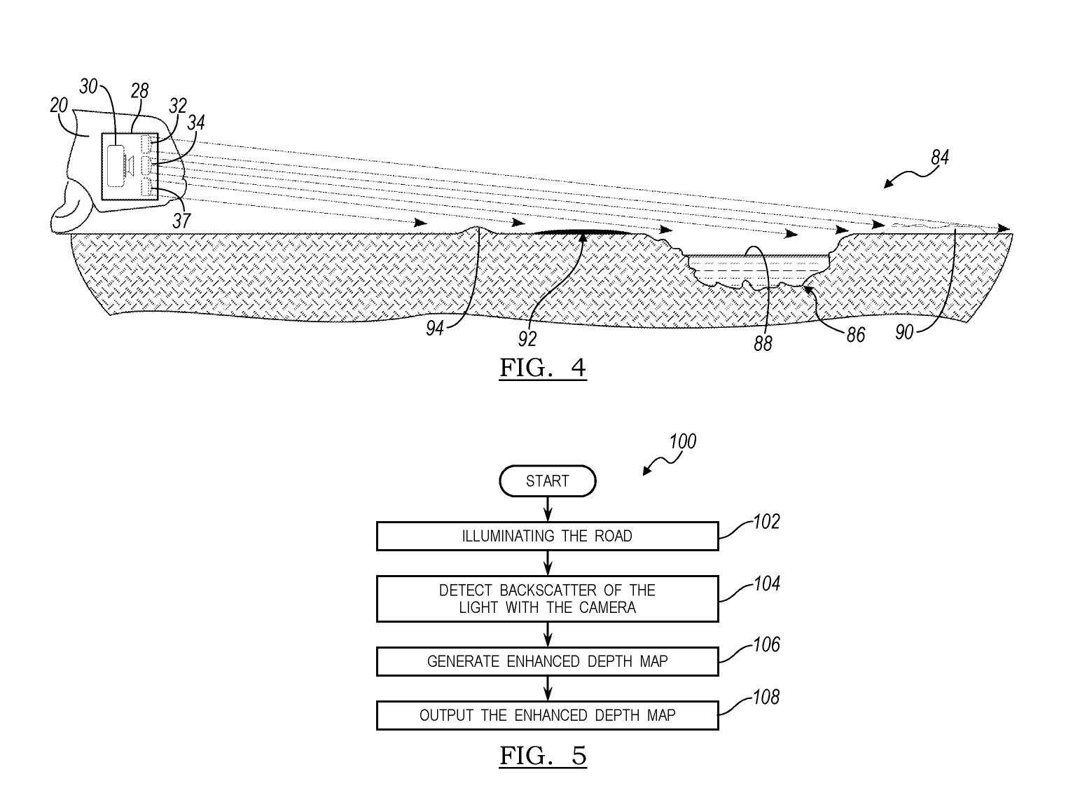

Referring to FIG. 4, an upcoming road segment 84, that is located about 50 feet in front of the vehicle, includes a pothole 86 partially filled with ice 88, a puddle of a water 90, and a slick of oil 92. The vision system 28, if equipped with a plenoptic camera, is able to create an enhanced depth map including information about the location, size, and depth of the pothole 86 and indicating the presence of the ice 88, water 90, or oil 92. The depth map indicates both the bottom of the pothole beneath the ice and the top of the ice. The vision system 28 utilizes the first light source 34 to detect the ice. The light from the first light source is mostly absorbed by the ice: the camera 30 detects the low intensity of that light and determines that ice is present. A portion of the light sources 32, 37 reflect off the top of the ice and a portion transmits through the ice and reflects back off the bottom of the pothole 86. The vision system 28 utilizes this to determine the bottom of the pothole 86 and the top of the ice 88.

The controller may use other sensor data to verify the ice reading. For example, the controller can check an outside air temperature when ice is detected. If the air temperature is above freezing by a predetermined amount, then the controller determines the ice reading to be false. The vehicle is periodically (e.g., every 100 milliseconds) generating a depth map. Previous depth maps can also be used to verify the accuracy of a newer depth map.

The vehicle may utilize the first light source 32 in a similar manner to determine the presence of water on the road segment 84. For example, as the vehicle 20 travels near the water 90, the camera 30 will detect the water due to the low intensity back scatter of the water image as compared to the background image (or a comparative image) of the road segment. Light from the other light sources are able to penetrate through the water allowing the camera to detect the road surface beneath the water. This allows the system to determine a depth of the puddle 90.

The vehicle may utilize the third light source 37 to detect the presence of oil 92 on the road segment 84. The camera 30 will detect the oil due to the low intensity backscatter of the oil image compared to the background image (or comparative image) of the road segment.

The vehicle 20 is also able to detect the bump 94 on the road surface using the camera 30. The camera 30 is configured to output a depth map to the controller 46 that includes information about the bump 94. This information can then be used to modify vehicle components.

In some embodiments, the processor 42 processes the raw data from the images and creates the enhanced depth map. The processor 42 then sends the enhanced depth map to the controller 46. The controller 46 uses the depth map to control other vehicle systems. For example, this information can be used to warn the driver via the display 48 and/or the audio system 50, and can be used to adjust the suspension system 26, the ABS 23, the traction-control system, the stability-control system, or other active or semi-active systems.

Referring back to FIG. 1, the suspension system 26 may be an active or semi-active suspension system having adjustable ride height and/or dampening rates. In one example, the suspension system includes electromagnetic and magneto-rheological dampeners 41 filled with a fluid whose properties can be controlled by a magnetic field. The suspension system 26 is controlled by the controller 46. Using the data received from the vision system 28, the controller 46 can modify the suspension 26 to improve the ride of the vehicle. For example, the vision system 28 detects the pothole 54 and the controller 46 instructs the suspension to adjust accordingly to increase ride quality over the pothole. The suspension system 26 may have an adjustable ride height and each wheel may be individually raised or lowed. The system 26 may include one or more sensor for providing feedback signals to the controller 46.

In another example, the suspension system 26 is an air-suspension system including at least air bellows and a compressor that pumps air into (or out of) the air bellows to adjust the ride height and stiffness of the suspension. The air system is controlled by the controller 46 such that the air suspension may be dynamically modified based on road conditions (e.g., the depth map) and driver inputs.

The vehicle also includes ABS 23 that typically sense wheel lockup with a wheel sensor. Data from the wheel sensors are used by the valve-and-pump housing to reduce (or eliminate) hydraulic pressure to the sliding wheel (or wheels) allowing the tire to turn and regain traction with the road. These systems typically do not engage until one or more of the wheels have locked-up and slide on the road. It is advantageous to anticipate a lockup condition prior to lockup actually occurring. Data from the vision system 28 can be used to anticipate a sliding condition prior to any of the wheels actually locking up. For example, if the enhanced depth map indicates an ice patch (or an oil slick) in a path of one or more of the wheels, the ABS 23 can be modified ahead of time to increase braking effectiveness on the ice (or oil). The controller 46 (or another vehicle controller) may include algorithms and lookup tables containing strategies for braking on ice, water, snow, oil, and other surface conditions.

Moreover, if the surface-coefficient of friction (u) is known, the controller can modulate the braking force accordingly to optimize braking performance. For example, the controller can be programmed to provide wheel slip, between the wheels and the road, of approximately 8% during braking to decrease stopping distance. The wheel slip is a function of u, which is dependent upon the road surface. The controller can be preprogrammed with u values for pavement, dirt, ice, water, snow, oil, and surface roughness (e.g., potholes, broken pavement, loose gravel, ruts, etc.) The vision system 28 can identify road conditions allowing the controller 46 to select the appropriate u values for calculating the braking force. Thus, the controller 46 may command different braking forces for different road-surface conditions.

The vehicle 20 may also include a stability-control system that attempts to the keep the angular momentum of the vehicle below a threshold value. The vehicle 20 may include yaw sensors, torque sensors, steering-angle sensors, and ABS sensors (among others) that provide inputs for the stability-control system. If the vehicle determines that the current angular momentum exceeds the threshold value, the controller 46 intervenes and may modulate braking force and engine torque to prevent loss of control. The threshold value is a function of u and the smoothness of the road surface. For example, on ice, a lower angular momentum can result in a loss of vehicle control than on dry pavement, which requires a higher angular momentum to result in a loss of vehicle control. Thus, the controller 46 may be preprogrammed with a plurality of different angular-momentum threshold values for different detected road surfaces. The information provided by the enhanced depth map may be used by the controller to choose the appropriate angular-momentum threshold value to apply in certain situations. Thus, if ice is detected, for example, the stability-control system may intervene sooner than if the vehicle is on dry pavement. Similarly, if the depth map detects broken pavement the controller 46 may apply a lower threshold value than for smooth pavement.

FIG. 5 illustrates a flow chart 100 for generating an enhanced depth map according to one embodiment. The enhanced depth map can be created when the vision system includes a plenoptic camera. At operation 102 the vision system illuminates a segment of the road with at least one infrared source emitting light at wavelengths corresponding to a substance to be detected. A plenoptic camera monitors the road segment and detects the backscatter of the emitted light at operation 104. At operation 106 the plenoptic camera generates an enhanced depth map. At operation 108 the plenoptic camera outputs the enhanced depth map to one or more vehicle controllers. In some embodiments, the camera system may be programmed to determine if one or more of the lens of the camera are dirty or otherwise obstructed. Dirty or obstructed lens may cause false objects to appear in the images captured by the camera. The camera system may determine that one or more lens are dirty by determining if an object is only detected by one or a few lens. If so, the camera systems flags those lens as dirty and ignores data from those lens. The vehicle may also warn the driver that the camera is dirty or obstructed.

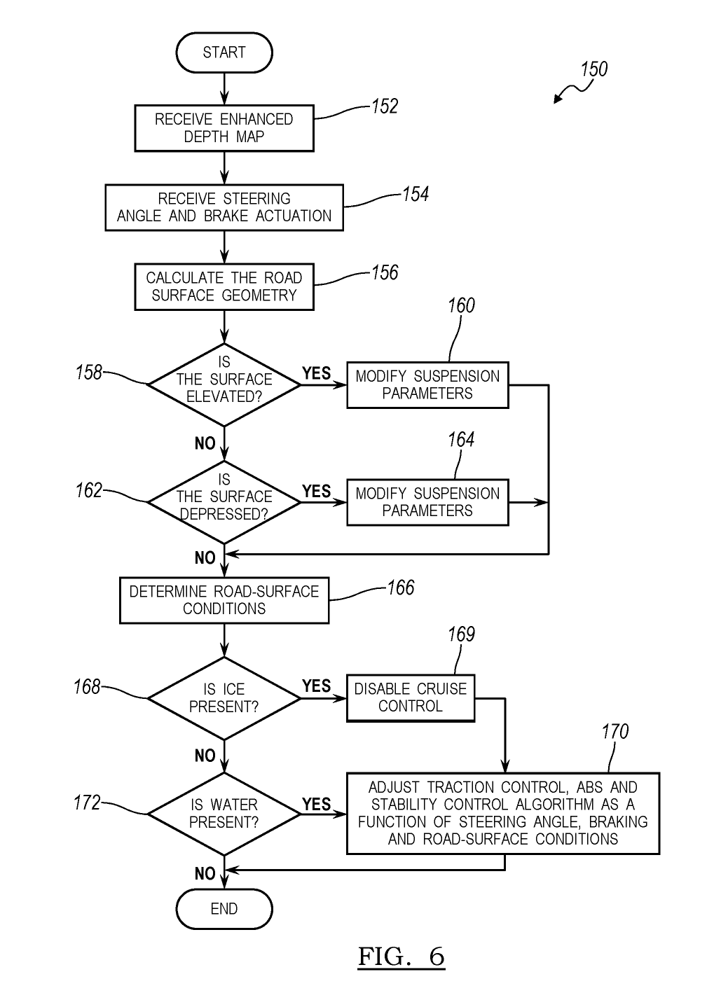

FIG. 6 illustrates a flow chart 150 for controlling the active and semi-active vehicle systems according to one embodiment. At operation 152 the controller receives the enhanced depth map from the camera system. At operation 154 the controller receives sensor data from various vehicle sensors such as the steering angle and the brake actuation. At operation 156 the controller calculates the road surface geometry using information from the enhanced that map. At operation 158 the controller determines if the road surface is elevated by evaluating the depth map for bumps. If an elevated surface is detected in the depth map, control passes to operation 160 and the vehicle identifies the affected wheels and modifies the suspension and/or the braking force (depending on current driving conditions) to improve driving dynamics. For example, if a bump is detected, the affected wheel may be raised by changing the suspension ride height for that wheel and/or the suspension stiffness may be softened to reduce shutter felt by the driver. If at operation 158 the surface is not elevated, control passes to operation 162 and the controller determines if the road surface has a depression. If the road surface is depressed, the suspension parameters are modified to increase vehicle ride quality over the depression. For example, if a pothole is detected, the affected wheel may be raised by changing the suspension ride height for that wheel and/or the suspension stiffness may be softened to reduce shutter felt by the driver. At operation 166, the controller determines road-surface conditions using information from the enhanced depth map and other vehicle sensors. For example, the controller may determine if the road is paved or gravel, and may determine if water, ice, or oil is present on the road surface. At operation 168 the controller determines if ice is present on the road using the enhanced depth map.

If ice is present, control passes to operation 169 and the cruise control is disabled. Next, control passed to operation 170 and the controller adjusts the traction-control system, the ABS and the stability-control system to increase vehicle performance on the icy surface. These adjustments may be based on a function of the steering angle, the current braking, and the road-surface conditions. If ice is not detected, control passes to operation 172 and the controller determines if water is present. If water is present, control passes to operation 170 where the traction control, ABS and stability control are modified based on the presence of the water. While not illustrated in FIG. 6, the algorithim 150 may include operations for modifying the vehicle systems if oil or other substance is present on the road.

While example embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A method of inspecting a road comprising:
generating a flash of infra-red light at an oil-absorption wavelength to illuminate a portion of the road; and
in response to a difference in backscatter intensity of an image of the portion captured during the flash and an image of the portion captured before or after the flash being greater than a threshold amount, outputting a signal indicating presence of oil on the portion.

2. The method of claim 1 wherein the oil-absorption wavelength is between 1720 to 1730 nanometers (nm) or is between 2300 to 2320 nm.

3. The method of claim 1 further comprising:
generating a second flash of infra-red light at a water-absorption wavelength to illuminate a second portion of the road; and
in response to a difference in backscatter intensity of an image of the second portion captured during the second flash and an image of the second portion captured before or after the second flash being greater than a second threshold amount, outputting a signal indicating presence of water on the second portion.

4. The method of claim 3 further comprising:
generating a third flash of infra-red light at an ice-absorption wavelength to illuminate a third portion of the road; and
in response to a difference in backscatter intensity of an image of the third portion captured during the third flash and an image of the third portion captured before or after the third flash being greater than a third threshold amount, outputting a signal indicating presence of ice on the third portion.

5. The method of claim 1 further comprising:
generating a second flash of infra-red light at a water-absorption wavelength to illuminate the portion of the road; and
in response to a difference in backscatter intensity of an image of the portion captured during the second flash and the image of the portion captured during the flash being greater than a second threshold amount, outputting a signal indicating presence of water on the portion.

6. The method of claim 1 further comprising:
generating a second flash of infra-red light at an ice-absorption wavelength to illuminate the portion of the road; and
in response to a difference in backscatter intensity of an image of the portion captured during the second flash and the image of the portion captured during the flash being greater than a second threshold amount, outputting a signal indicating presence of ice on the portion.

7. The method of claim 6 further comprising:
in response to a difference in backscatter intensity of the image of the portion captured during the flash and the image of the portion captured during the second flash being greater than the threshold amount, outputting a signal indicating presence of oil on the portion.

8. The method of claim 1 further comprising, in response to detecting oil, adjusting a parameter of a braking system of a vehicle.

9. A vehicle comprising:
an infrared source configured to emit light at an oil-absorption wavelength;
a camera; and
a controller programmed to
command the infrared source to illuminate a portion of a road with a flash of the light,
command the camera to capture a first image of the portion during the flash,
command the camera to capture a second image of the portion before or after the flash, and
in response to a difference in backscatter intensity of the first image and the second image being greater than a threshold amount, output a signal indicating presence of oil on the portion.

10. The vehicle of claim 9 wherein the controller is further programmed to:
generate a second flash of infra-red light at an ice-absorption wavelength to illuminate the portion of the road, wherein the second flash occurs before or after the flash; and
in response to a difference in backscatter intensity of a third image of the portion captured during the second flash and the first image being greater than a second threshold amount, output a signal indicating presence of ice on the portion.

11. The vehicle of claim 10 wherein the controller is further programmed to, in response to a difference in backscatter intensity of the third image and the first image being greater than a third threshold amount, output a signal indicating presence of oil on the portion.

12. The vehicle of claim 9 further comprising a second infrared source configured to emit light at an ice-absorption wavelength, wherein the controller is further programmed to command the second infrared source to illuminate the portion of the road with a second flash of light at the ice-absorption wavelength, command the camera to capture a third image of the portion during the second flash, and in response to a difference in backscatter intensity of the third image and the second image being greater than a second threshold amount, output a signal indicating presence of ice on the portion.

13. The vehicle of claim 9 wherein the camera is a plenoptic camera.

14. The vehicle of claim 9 wherein the infrared source includes one or more light emitting diodes configured to emit light at the oil-absorption wavelength.

15. A method of inspecting a road comprising:
generating a flash of infra-red light at a wavelength to illuminate a portion of the road, wherein the wavelength corresponds to an absorption wavelength of a substance to be detected; and
in response to a difference in backscatter intensity of an image of the portion captured during the flash and an image of the portion captured before or after the flash being greater than a threshold amount, outputting a signal indicating presence of the substance on the portion.

16. The method of claim 15 wherein the substance to be detected is water, and wherein the wavelength is a water-absorption wavelength.

17. The method of claim 16 wherein the wavelength is between one of 965 to 975 nm, 1195 to 1205 nm, 1445 to 1455 nm, and 1945 to 1955 nm.

18. The method of claim 15 wherein the substance to be detected is ice, and wherein the wavelength is an ice-absorption wavelength.

19. The method of claim 18 wherein the wavelength is between 1615 to 1625 nm.

20. The method of claim 15 further comprising:
generating a second flash of infra-red light at a second wavelength to illuminate the portion of the road, wherein the second wavelength corresponds to an absorption wavelength of a second substance to be detected which is different than the substance; and
in response to a difference in backscatter intensity of an image of the portion captured during the second flash and an image of the portion captured before or after the second flash being greater than a second threshold amount, outputting a signal indicating presence of the second substance on the portion.
